(19) United States
(12) Patent Application Publication
(10) Pub. No.: US 2014/0146532 A1
(43) Pub. Date: May 29, 2014

(54) LED Illuminating Device

(71) Applicant: Tai-Chiang Lin, Surrey (CA)

(72) Inventor: Tai-Chiang Lin, Surrey (CA)

(21) Appl. No.: 13/684,835

(22) Filed: Nov. 26, 2012

(51) Int. Cl. F21V 29/00; F21V 3/00

(52) U.S. Cl. CPC F21V 29/002; F21V 3/00
USPC 362/235

(57) ABSTRACT

An LED illuminating device includes a heat-dissipating lamp seat having a plurality of fins on a top side thereof and a recessed portion on a bottom side thereof. A fixing seat is mounted to the top side of the heat-dissipating lamp seat and includes a channel. The fixing seat has a width smaller than a width of the heat-dissipating lamp seat. A power supply unit is mounted in the channel of the fixing seat and includes a connecting assembly. A light-emitting diode (LED) assembly is fixed in the recessed portion and includes a plurality of circuit boards. A plurality of LEDs is electrically connected to a bottom face of each circuit board and electrically connected to the connecting assembly. A diffuser is fixed to the bottom side of the heat-dissipating lamp seat and covers the LED lamp assembly.

### BACKGROUND OF THE INVENTION

The present invention relates to an LED illuminating device and, more particularly, to an LED illuminating device providing a larger illumination area and a heat dissipating effect.

Conventional illuminating light sources including bulbs, fluorescent lamps or mercury lamps have disadvantages, such as poor illumination efficiency, large power consumption, liability to damage, and short service lives.

Light-emitting diode (LED) devices provide advantages of excellent illumination efficiency, low power consumption, and long service lives. However, the high temperature resulting from conversion between electricity and light must be dissipated to avoid disadvantages including reduced illuminating effect, shortened service lives and luminous depreciation.

However, the LEDs are mounted in a small area of the currently available LED devices and, thus, provide limited illumination. Furthermore, the high temperature generated by the LEDs can not be conducted rapidly, resulting in poor heat dissipating effect and a low heat dissipating speed, causing the above disadvantages.

### BRIEF SUMMARY OF THE INVENTION

An objective of the present invention is to provide an LED illuminating device providing a larger illumination area, enhanced illumination effect, and a longer service life while providing excellent heat dissipating efficiency and a high heat dissipating speed.

An LED illuminating device according to the present invention includes a heat-dissipating lamp seat having a top side and a bottom side opposite to the top side. A plurality of fins is provided on the top side. The bottom side includes a recessed portion. A fixing seat is mounted to the top side of the heat-dissipating lamp seat. The fixing seat includes a channel having two ends. First and second end caps are mounted to the ends of the channel. The fixing seat has a width smaller than a width of the heat-dissipating lamp seat. A power supply unit is mounted in the channel of the fixing seat. The power supply unit includes a substrate, a power supply fixed to the substrate, and a connecting assembly fixed to the substrate and electrically connected to the power supply. A light-emitting diode (LED) assembly is fixed in the recessed portion of the heat-dissipating lamp seat. The LED assembly includes a plurality of circuit boards and a power cord. A plurality of LEDs is electrically connected to a bottom face of each of the plurality of circuit boards and electrically connected to the connecting assembly. A diffuser is fixed to the bottom side of the heat-dissipating lamp seat and covers the LED lamp assembly. Light beams generated by each of the plurality of LEDs are adapted to transmit downward through the diffuser.

Preferably, the fixing seat includes a bottom mounted to an intermediate portion of the top side of the heat-dissipating lamp seat, and the width of the heat-dissipating lamp seat is three to five times of the width of the fixing seat.

Preferably, the bottom of the fixing seat is connected by a connecting rib to the intermediate portion of the top side of the heat-dissipating lamp seat.

Preferably, the heat-dissipating lamp seat, the plurality of fins, and the fixing seat have an identical length.

Preferably, the power supply includes an input end connected to a power wire. The heat-dissipating lamp seat includes a through-hole in communication with the channel. The power cord of the LED assembly is extended through the through-hole into the channel and electrically connected to the connecting assembly.

Preferably, the channel of the fixing seat includes two lateral grooves, and the substrate includes two lateral edges received in the lateral grooves.

Preferably, the substrate includes an end having a tab with at least one fixing hole. The first end cap includes at least one through-hole. At least one bolt extends through the at least one through-hole into the at least one fixing hole of the tab.

Preferably, a frame is mounted around the diffuser and includes a plurality of through-holes. The bottom side of the heat-dissipating lamp seat includes a plurality of screw holes. A bolt is extended through each of a plurality of through-holes of the frame into one of the plurality of screw holes. The frame includes an inner periphery having four sides. A gasket is mounted to each of the four sides of the inner periphery of the frame. Each gasket includes an engagement groove receiving one of the four sides of the diffuser.

The present invention will become clearer in light of the following detailed description of illustrative embodiments of this invention described in connection with the drawings.

### DESCRIPTION OF THE DRAWINGS

FIG. 1 shows a top, perspective view of an LED illuminating device according to the present invention.

FIG. 2 shows a bottom, perspective view of the LED illuminating device of FIG. 1.

FIG. 3 is an enlarged, perspective view of an end of the LED illuminating device of FIG. 2.

FIG. 4 is an enlarged, perspective view of the other end of the LED illuminating device of FIG. 2.

FIG. 5 is an exploded, perspective view of the other end of the LED illuminating device shown in FIG. 4.

FIG. 6 is a cross sectional view of the other end of the LED illuminating device shown in FIG. 4.

FIG. 7 is a cross sectional view taken along section line A-A of FIG. 6.

FIG. 8 is an enlarged, perspective view of the end of the LED illuminating device shown in FIG. 3.

FIG. 9 is an, exploded perspective view of the end of the LED illuminating device shown in FIG. 8.

### DETAILED DESCRIPTION OF THE INVENTION

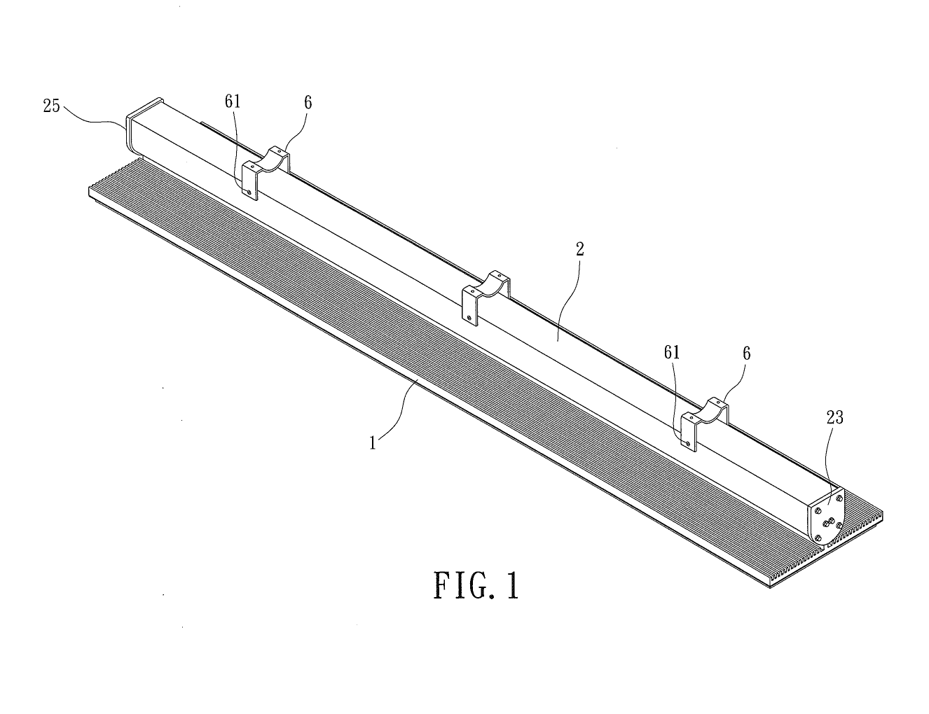

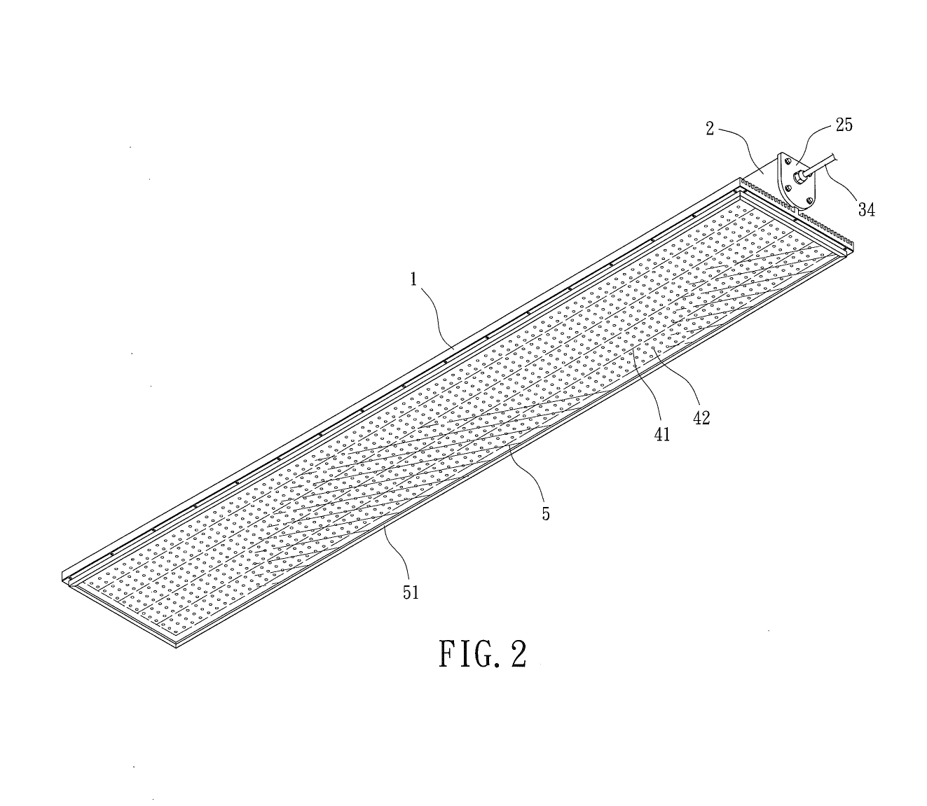

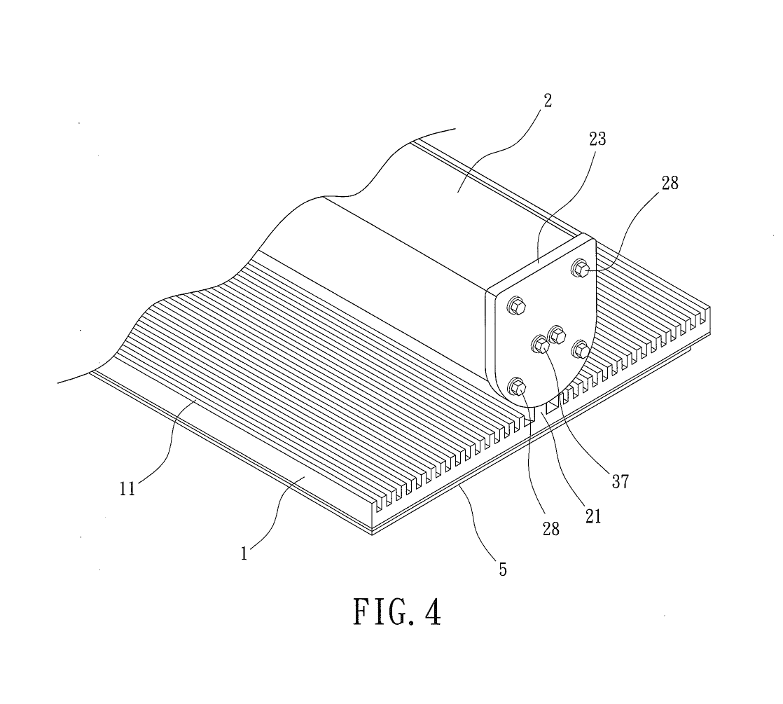

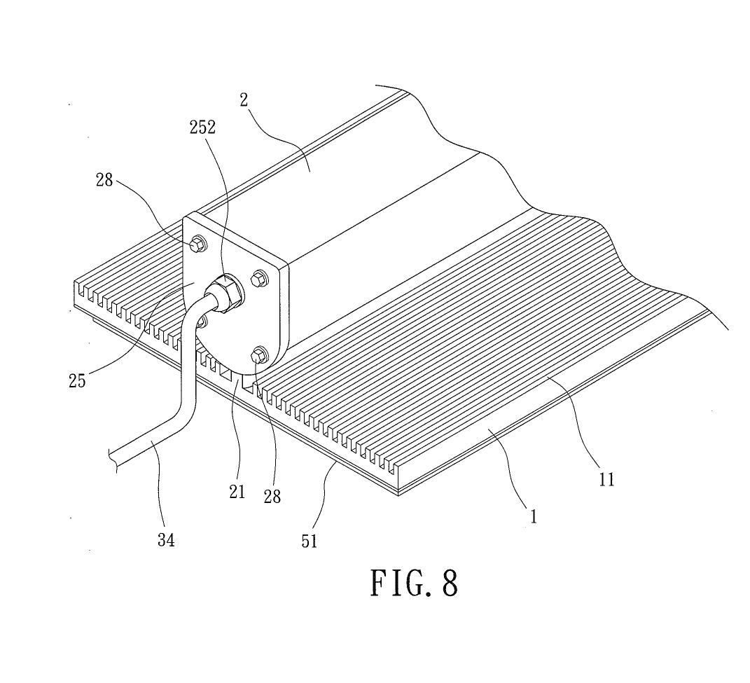

With reference to FIGS. 1-9, an illuminating device according to the present invention includes a heat-dissipating lamp seat 1, a fixing seat 2, a power supply unit 3, a light-emitting diode (LED) assembly 4, and a diffuser 5. Fixing members 6 can be fixed to the fixing seat 2 by bolts 61.

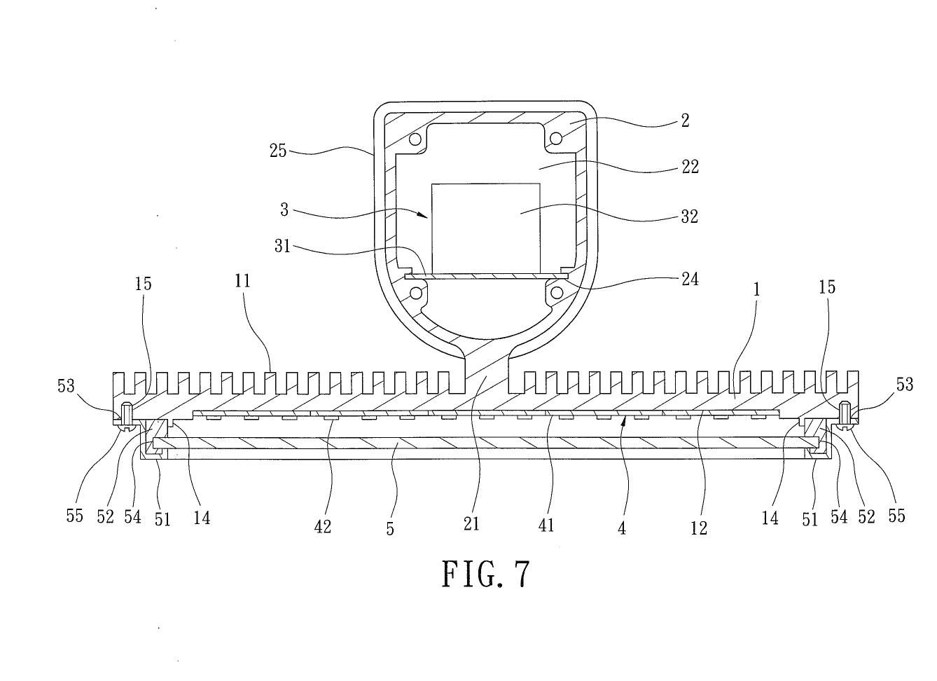

The heat-dissipating lamp seat 1 is a metal housing and includes a top side and a bottom side opposite to the top side. A plurality of fins 11 is provided on the top side. The bottom side includes a recessed portion 12, a ridge 14 formed along each of four edges thereof, and a plurality of screw holes 15 (FIG. 7).

The fixing seat 2 is mounted to an intermediate portion of the top side of the heat-dissipating lamp seat 1. A bottom of the fixing seat 1 is connected by a connecting rib 21 to the intermediate portion of the top side of the heat-dissipating lamp seat 1, with the connecting rib 21 integrally formed with the fixing seat 1 and the heat-dissipating lamp seat 1. The heat-dissipating lamp seat 1, the fins 11, and the fixing seat 2 have an identical length. The fixing seat 2 includes a channel 22 having two ends, with first and second end caps 23 and 25 mounted to the ends of the channel 22. Each end of the channel 22 includes a plurality of screw holes 26. Each of the first and second end caps 23 and 25 has a plurality of through-holes 27. Bolts 28 are extended through the through-holes 27 of the first and second end caps 23 and 25 into the screw holes 26, fixing the first and second end caps 23 and 25 to the ends of the channel 22. Furthermore, the channel 22 of the fixing seat 2 includes two lateral grooves 24. A width of the fixing seat 2 is smaller than a width of the heat-dissipating lamp seat 1. Preferably, the width of the heat-dissipating lamp seat 1 is three to five times of the width of the fixing seat 2.

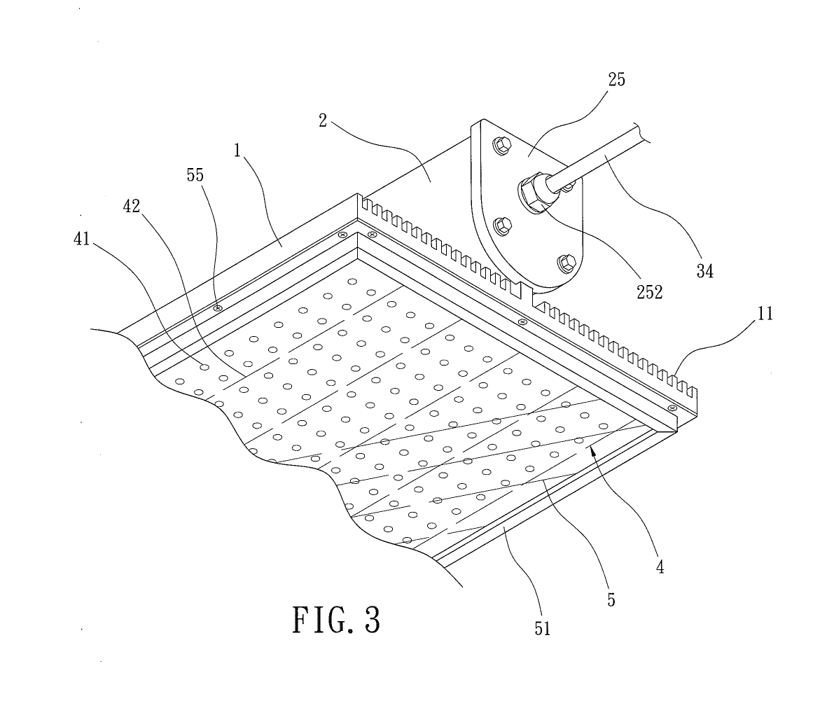

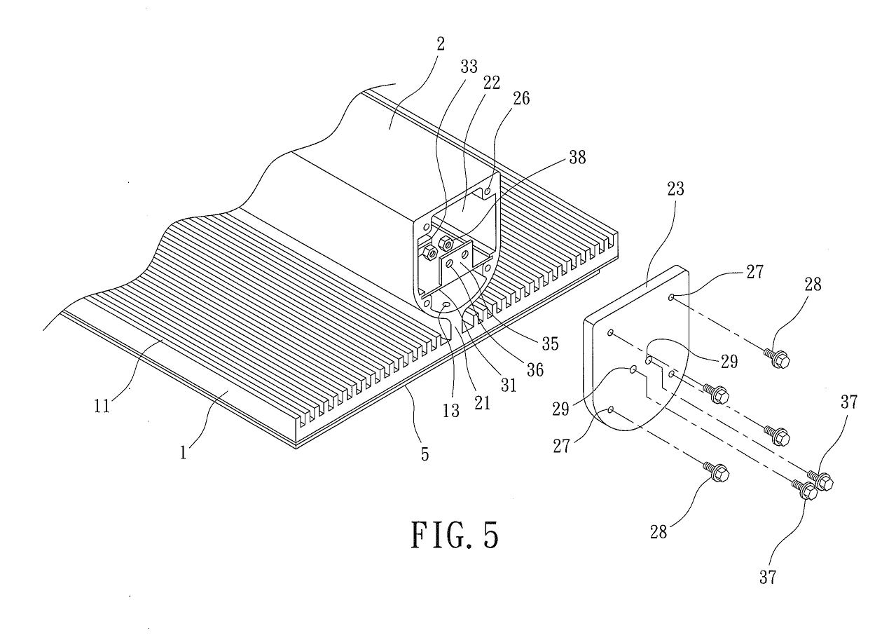

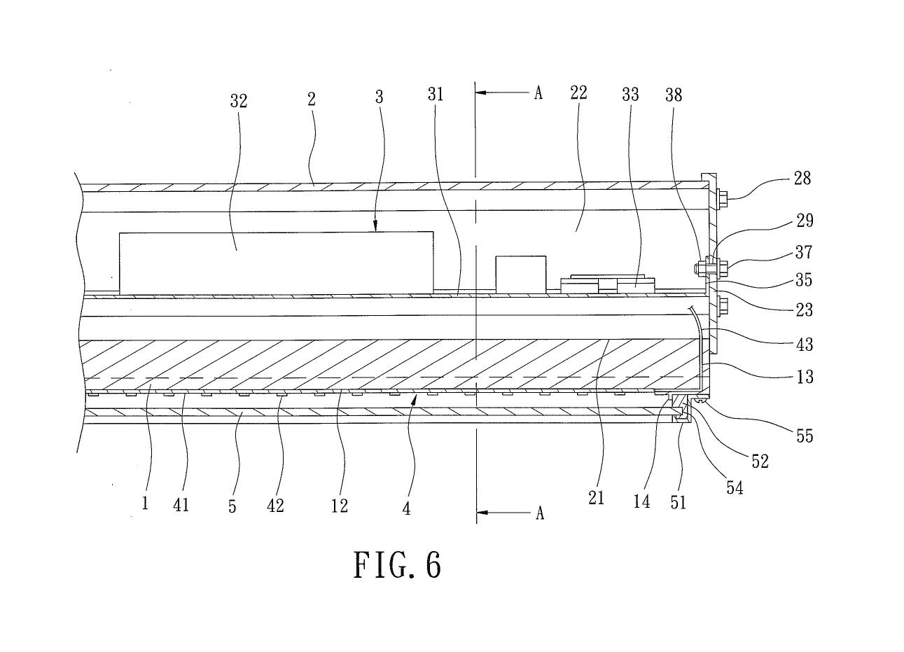

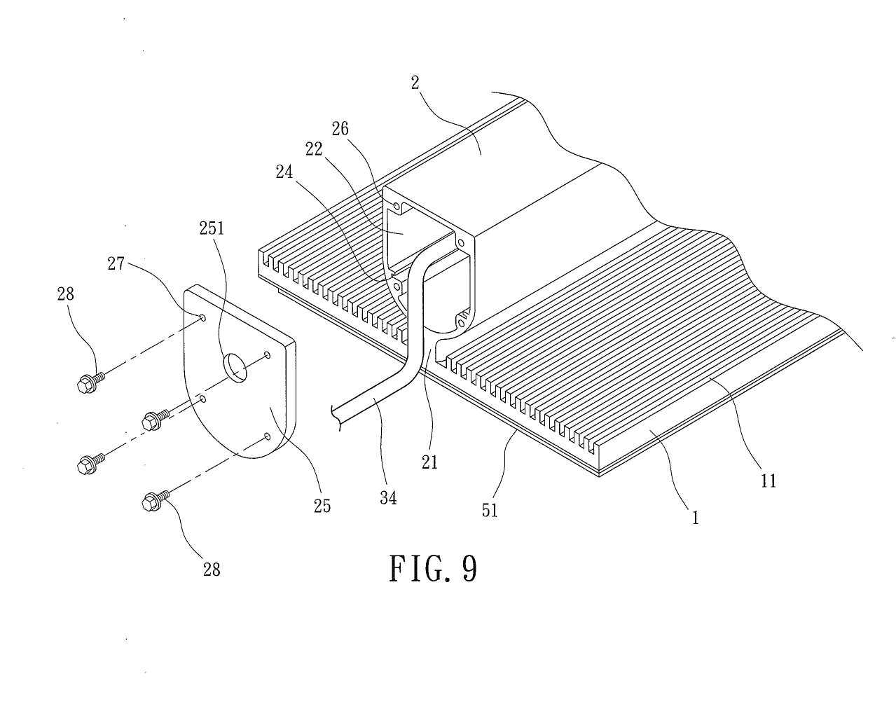

The power supply unit 3 is mounted in the channel 22 of the fixing seat 2. The power supply unit 3 includes a substrate 31 having two lateral edges received in the lateral grooves 24. The power supply unit 3 further includes a power supply 32 fixed to the substrate 31 and having a power wire 34 extending through a hole 251 in the second end cap 25 (FIG. 9) and a cable gland 252 (FIG. 3). The power supply unit 3 further includes a connecting assembly 33 fixed to the substrate 31 and electrically connected to the power supply 32. The substrate 31 includes an end having a tab 35 with at least one fixing hole 36 (FIGS. 5 and 6). The first end cap 23 includes at least one through-hole 29. At least one bolt 37 is extended through the at least one through-hole 29 into the at least one fixing hole 36 of the tab 35 and then fixed by at least one nut 38.

The light-emitting diode (LED) assembly 4 is fixed in the recessed portion 12 of the heat-dissipating lamp seat 1. The LED assembly 4 includes a plurality of circuit boards 41 and a power cord 43. A plurality of LEDs 42 is electrically connected to a bottom face of each circuit board 41 and electrically connected to the connecting assembly 33. The heat-dissipating lamp seat 1 includes a through-hole 13 in communication with the channel 22. The power cord 43 of the LED assembly 4 is extended through the through-hole 13 into the channel 22 and electrically connected to the connecting assembly 33 (FIG. 6).

The diffuser 5 is fixed to the bottom side of the heat-dissipating lamp seat 1 and covers the LED lamp assembly 4 (FIGS. 6 and 7). A frame 51 is mounted around the diffuser 5. The frame 51 includes a plurality of through-holes 53. A bolt 55 is extended through each through-hole 53 of the frame 51 into one of the screw holes 15 in the bottom side of the heat-dissipating lamp seat 1. The frame 51 includes an inner periphery having four sides, with a gasket 52 mounted to each of the four sides of the inner periphery of the frame 51. Each gasket 52 includes an engagement groove 54 receiving one of the four sides of the diffuser 5. The light beams generated by each LED 42 transmit downward through the diffuser 5 that also provides waterproof and dustproof effects.

In the LED illuminating device according to the present invention, the power supply unit 3 is mounted in the channel 22 in the fixing seat 2. Furthermore, the heat-dissipating lamp seat 1, the LED assembly 4, and the diffuser 5 are mounted to the bottom of the fixing seat 2 providing a large area for heat conduction for heat dissipating purposes. The illumination area is increased, the illuminating effect is enhanced, and the service life of the LED illuminating device is prolonged while providing excellent heat dissipating effect and a high heat dissipating speed. This avoids disadvantages resulting from high temperature while providing waterproof and dustproof effects. Further, the length of the heat-dissipating lamp seat 1, the fixing seat 2, and the LED assembly 4 can be varied according to needs in the illuminating effect, illumination area, and brightness.

Although specific embodiments have been illustrated and described, numerous modifications and variations are still possible without departing from the essence of the invention. The scope of the invention is limited by the accompanying claims.

1. An LED illuminating device comprising:
a heat-dissipating lamp seat including a top side and a bottom side opposite to the top side, with the bottom side including a recessed portion;
a fixing seat mounted to the top side of the heat-dissipating lamp seat, with the fixing seat including a channel having two ends, with first and second end caps mounted to the two ends of the channel, with the fixing seat having a width smaller than a width of the heat-dissipating lamp seat;
a power supply unit mounted in the channel of the fixing seat, with the power supply unit including a substrate, a power supply fixed to the substrate, and a connecting assembly fixed to the substrate and electrically connected to the power supply;
a light-emitting diode (LED) assembly fixed in the recessed portion of the heat-dissipating lamp seat, with the LED assembly including a plurality of circuit boards and a power cord, with a plurality of LEDs electrically connected to a bottom face of each of the plurality of circuit boards and electrically connected to the connecting assembly; and
a diffuser fixed to the bottom side of the heat-dissipating lamp seat and covering the LED lamp assembly, with light beams generated by each of the plurality of LEDs adapted to transmit downward through the diffuser.

2. The LED illuminating device as claimed in claim 1, with the fixing seat including a bottom mounted to an intermediate portion of the top side of the heat-dissipating lamp seat, with the width of the heat-dissipating lamp seat being three to five times of the width of the fixing seat.

3. The LED illuminating device as claimed in claim 2, with the bottom of the fixing seat connected by a connecting rib to the intermediate portion of the top side of the heat-dissipating lamp seat.

4. The LED illuminating device as claimed in claim 2, with a plurality of fins provided on the top side, with the heat-dissipating lamp seat, the plurality of fins, and the fixing seat having an identical length.

5. The LED illuminating device as claimed in claim 1, with the power supply including an input end connected to a power wire, with the heat-dissipating lamp seat including a through-hole in communication with the channel, with the power cord of the LED assembly extended through the through-hole into the channel and electrically connected to the connecting assembly.

6. The LED illuminating device as claimed in claim 5, with the channel of the fixing seat including two lateral grooves, with the substrate including two lateral edges received in the two lateral grooves.

7. The LED illuminating device as claimed in claim 6, with the substrate including an end having a tab with at least one fixing hole, with the first end cap including at least one through-hole, with at least one bolt extending through the at least one through-hole into the at least one fixing hole of the tab.

8. The LED illuminating device as claimed in claim 1, further comprising: a frame having a plurality of through-holes, with the bottom side of the heat-dissipating lamp seat including a plurality of screw holes, with a bolt extended through each of the plurality of through-holes of the frame into one of the plurality of screw holes.

9. The LED illuminating device as claimed in claim 8, with the frame including an inner periphery having four sides, with a gasket mounted to each of the four sides of the inner periphery of the frame, with each of the gaskets including an engagement groove receiving one of the four sides of the diffuser.
